(19) United States
(12) Patent Application Publication
(10) Pub. No.: US 2026/0356270 A1
(43) Pub. Date: Nov. 12, 2026

(54) DUMP TRUCK

(71) Applicant: KOMATSU LTD., Tokyo (JP)

(72) Inventors: Yuta Hoshino, Tokyo (JP); Ryosuke Maeda, Tokyo (JP); Yuuki Ishikawa, Tokyo (JP); Masafumi Kuroda, Tokyo (JP); Shuhei Kousaka, Tokyo (JP)

(73) Assignee: KOMATSU LTD., Tokyo (JP)

(21) Appl. No.: 19/130,610

(22) PCT Filed: Nov. 10, 2023
(86) PCT No.: PCT/JP2023/040558

§ 371 Date: May 16, 2025

(30) Foreign Application Priority Data
Dec. 28, 2022 (JP) 2022-211765

(51) Int. Cl. B60P 1/30; B60P 1/28

(52) U.S. Cl. CPC B60P 1/30; B60P 1/28

(57) ABSTRACT

This dump truck includes a dump body rotatably coupled to a vehicle body frame and on which a load is loaded, the dump truck including an ultrasonic device that emits an ultrasonic wave, in which the ultrasonic device is included on the dump body.

### TECHNICAL FIELD

The present invention relates to a dump truck.

The present invention claims priority based on Japanese Patent Application No. 2022-211765 filed in Japan on Dec. 28, 2022, the content of which is incorporated herein by reference.

### BACKGROUND ART

Zero emission of mining machines, construction machines, and the like is urgently needed for carbon neutral. As a promising idea for achieving zero emission, there are a trolley vehicle including a battery and a fuel cell vehicle. In an existing dump truck, a dump body is heated using waste heat of exhaust gas of an engine. As a result, freezing of transported earth and sand in a cold district is prevented, and highly viscous earth and sand are dried, thereby enhancing the soil discharging property. However, in a trolley vehicle including a battery or a fuel cell vehicle, the temperature of waste heat is lower than that of an engine vehicle. Therefore, in order to improve the soil discharging property in a trolley vehicle including a battery or a fuel cell vehicle, a mechanism that replaces heating of a dump body using waste heat is required.

For example, Patent Literature 1 discloses a dump truck including a cargo bed heating mean that heats a cargo bed. The cargo bed heating mean includes an electric heating line included in the cargo bed. For example, in the case of an electrically driven dump truck including a resistor that converts electric power generated by a retarder brake operation into thermal energy, the electric heating line includes a part of the resistor. For example, in the case of a dump truck including a battery and a control unit, electric power is supplied from the battery to the electric heating line by the control unit. For example, in the case of a trolley-type dump truck including a current collection device that obtains electric power from an overhead line, the electric power obtained from the overhead line by the current collection device is supplied to the electric heating line.

### CITATION LIST

### Patent Literature

Patent Literature 1: JP 2012-183900 A

### SUMMARY OF INVENTION

### Technical Problem

However, since heat is locally transferred to an electric heating line, excessive electric power needs to be supplied to the electric heating line depending on an installation mode of the electric heating line in a cargo bed. Therefore, there is room for improvement in reducing electric power consumption.

Therefore, an object of the present invention is to provide a dump truck capable of improving a soil discharging property and reducing electric power consumption.

### Solution to Problem

A dump truck according to one aspect of the present invention is a dump truck including a dump body rotatably coupled to a vehicle body frame and on which a load is loaded, and includes an ultrasonic device that emits an ultrasonic wave, in which the ultrasonic device is included on the dump body.

### Advantageous Effects of Invention

According to the above aspect, the soil discharging property can be improved and the electric power consumption can be reduced.

### BRIEF DESCRIPTION OF DRAWINGS

FIG. 1 is a side view of a dump truck according to a first embodiment.

FIG. 2 is an explanatory diagram of an installation place of an ultrasonic device in a dump body according to the first embodiment.

FIG. 3 is an explanatory diagram of an installation location of a vibrator at an inner bottom portion according to the first embodiment.

FIG. 4 is an explanatory diagram of a flow of electricity or the like during traveling in a fuel cell system according to the first embodiment.

FIG. 5 is an explanatory diagram of a flow of electricity or the like during regeneration in the fuel cell system according to the first embodiment.

FIG. 6 is a side view of a dump truck according to a second embodiment.

### DESCRIPTION OF EMBODIMENTS

Hereinafter, embodiments of the present invention will be described with reference to the drawings. In the embodiments, a dump truck that is a transport vehicle that transports a load by traveling in a work site such as a mine will be described as a work vehicle included in a fuel cell system.

### First Embodiment

### <Dump Truck>

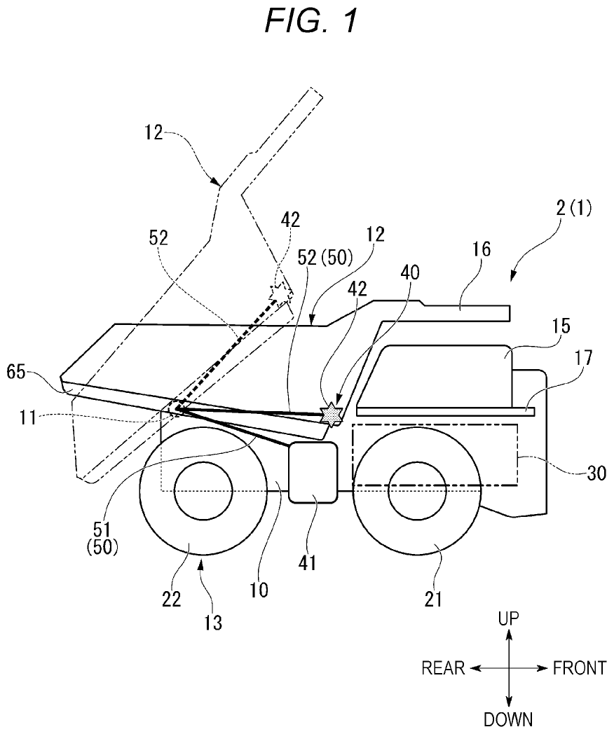

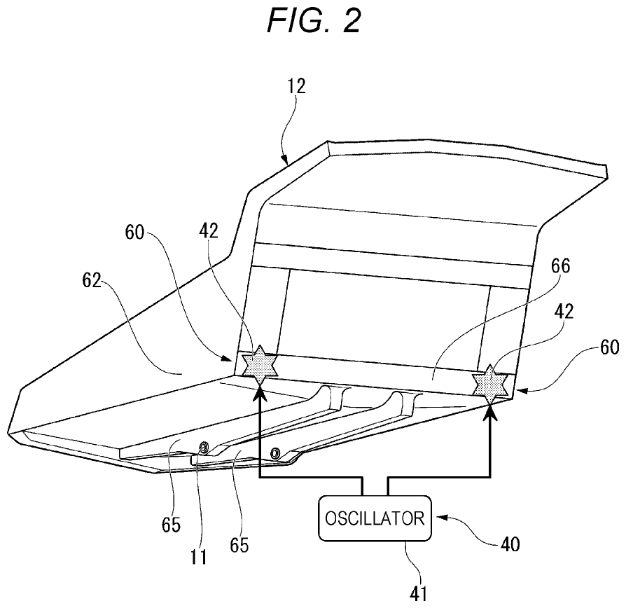

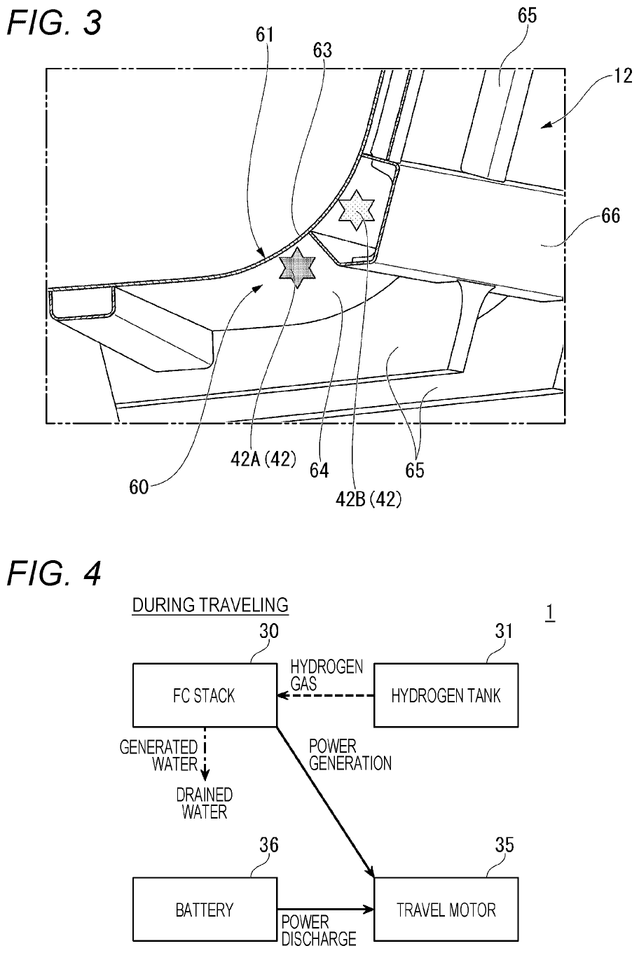

FIG. 1 is a side view of a dump truck 2 according to a first embodiment. FIG. 2 is an explanatory diagram of an installation place of an ultrasonic device 40 in a dump body 12 according to the first embodiment. FIG. 3 is an explanatory diagram of an installation location of a vibrator 42 at an inner bottom portion 63 according to the first embodiment.

Referring to FIGS. 1 to 3 altogether, the dump truck 2 includes a vehicle body frame 10 that includes a drive source 30 using hydrogen as fuel, the dump body 12 (corresponding to a vessel) rotatably coupled to the vehicle body frame 10 by a rotation unit 11 and on which a load is loaded, and a traveling device 13 that supports the vehicle body frame 10.

In the present embodiment, the dump truck 2 does not include an internal combustion engine. In the dump truck 2, no exhaust gas of the internal combustion engine is generated. For example, the dump truck 2 may be an unmanned dump truck that is driven in an unmanned manner without depending on a driving operation by a driver, or may be a manned dump truck that is driven on the basis of a driving operation by a driver.

Hereinafter, a forward direction (front side of the vehicle body), a backward direction (rear side of the vehicle body), and a vehicle width direction (left and right direction of the vehicle body) of the dump truck 2 are referred to as “vehicle front side (one side in the vehicle front and rear direction)”, “vehicle rear side (the other side in the vehicle front and rear direction)”, and “vehicle width direction”. The vehicle width direction may also be referred to as “left side (one side in the vehicle width direction)” or “right side (the other side in the vehicle width direction)”. A right hand in a direction in which the dump truck 2 moves forward is referred to as right side, and a left hand in a direction in which the dump truck 2 moves forward is referred to as left side. A vehicle vertical direction (vehicle body vertical direction), above the vehicle (above the vehicle body), and below the vehicle (below the vehicle body) of the dump truck 2 are simply referred to as “vertical direction”, “above”, and “below”. In the example of the drawing, the dump truck 2 is disposed on a horizontal plane (horizontal ground). The vehicle vertical direction (vehicle body vertical direction), the above the vehicle (above the vehicle body), and the below the vehicle (below the vehicle body) of the dump truck 2 coincide with the vertical direction (perpendicular direction), perpendicular above, and perpendicular below in a state where the dump truck 2 is disposed on a horizontal plane, respectively.

The vehicle body frame 10 extends in the vehicle front and rear direction. The vehicle body frame 10 rotatably supports the dump body 12 via the rotation unit 11. The rotation unit 11 is a portion including a shaft portion (corresponding to a rotation center axis of the dump body 12) that extends in the vehicle width direction on the vehicle body frame 10. The vehicle body frame 10 is supported by the traveling device 13.

The dump body 12 is rotatably coupled to the vehicle body frame 10 by the rotation unit 11. The dump body 12 is a member (corresponding to a cargo bed) on which a load is loaded. At least a part of the dump body 12 is disposed above the vehicle body frame 10. The dump body 12 can perform a dumping operation and a lowering operation.

The dumping operation means an operation of separating the dump body 12 from the vehicle body frame 10 and inclining the dump body in a dumping direction. The dumping direction is the rear side of the vehicle body frame 10. In the embodiment, the dumping operation includes raising the front end portion of the dump body 12 and inclining the dump body 12 backward. By the dumping operation, the loading surface of the dump body 12 is inclined downward and backward.

The lowering operation means an operation of bringing the dump body 12 close to the vehicle body frame 10. The lowering operation is an operation in a direction opposite to the dumping operation. In the embodiment, the lowering operation includes lowering the front end portion of the dump body 12.

The dump body 12 is adjusted to a dumping posture and a loading posture by the dumping operation and the lowering operation. The dumping posture means a posture in which the dump body 12 is raised. The loading posture means a posture in which the dump body 12 is lowered. In the example of FIG. 1, the dump body 12 in the loading posture is indicated by a solid line, and the dump body 12 in the dumping posture is indicated by a two-dot chain line.

For example, in a case where a soil discharging work is performed, the dump body 12 performs a dumping operation such that the posture is changed from the loading posture to the dumping posture. In a case where a load is loaded on the dump body 12, the load is discharged backward from the rear end portion of the dump body 12 by the dumping operation. On the other hand, in a case where a loading work is to be performed, the dump body 12 is adjusted to the loading posture.

The dump body 12 includes a protector 16 that protects a cab 15 from above. The protector 16 is disposed so as to cover the cab 15 from above in a case where the dump body 12 is in the loading posture. The protector 16 is included on the front end side of the dump body 12. The protector 16 is disposed above the cab 15. The protector 16 extends in the vehicle width direction. For example, the cab 15 is disposed on the vehicle left side of the center in the vehicle width direction.

The cab 15 is supported by a platform 17. The platform 17 is included above a front portion of the vehicle body frame 10. The platform 17 is included for securing scaffolding in a case where the operator gets on and off the cab 15. The platform 17 is included for securing scaffolding in the case of maintenance of mounted equipment of the dump truck 2. The platform 17 is disposed below the protector 16. The platform 17 is disposed above wheels 21 and 22. The platform 17 extends in the vehicle width direction. The platform 17 is formed in a plate shape parallel to the vehicle front and rear direction and the vehicle width direction.

The traveling device 13 supports the vehicle body frame 10. The traveling device 13 causes the dump truck 2 to travel. The traveling device 13 moves the dump truck 2 forward or backward. At least a part of the traveling device 13 is disposed below the vehicle body frame 10. The traveling device 13 includes a plurality of wheels 21 and 22. The plurality of wheels 21 and 22 includes front wheels 21 and rear wheels 22 disposed behind the front wheels 21.

The front wheels 21 are steering wheels steered so as to change the traveling direction of the dump truck 2. A pair of left and right front wheels 21 is disposed. The pair of left and right front wheels 21 is disposed at an interval in the vehicle width direction via the front portion of the vehicle body frame 10. One front wheel 21 (two in total) is included on each of the left and right sides.

The rear wheels 22 are drive wheels driven by the drive source 30. A pair of left and right rear wheels 22 is disposed. The pair of left and right rear wheels 22 is disposed at an interval in the vehicle width direction via the rear portion of the vehicle body frame 10. Two rear wheels 22 (four in total) are included on each of the left and right sides.

### <Ultrasonic Device>

The dump truck 2 includes an ultrasonic device 40 that emits an ultrasonic wave. The ultrasonic device 40 is included on the dump body 12. In the present embodiment, the ultrasonic device 40 is included at a front lower portion of the dump body 12. A load (not illustrated) such as earth and sand or a crushed stone is more likely to adhere to the front lower portion of the dump body 12 in contact with the load than to the rear portion of the dump body 12.

In the present embodiment, the ultrasonic device 40 operates according to a command from an operator. For example, the operator may operate the ultrasonic device 40 before transported earth and sand freeze in a cold district. For example, the operator may operate the ultrasonic device 40 before highly viscous earth and sand adhere. For example, the operation timing of the ultrasonic device 40 is not limited to the above, and can be changed according to the design specification.

The ultrasonic device 40 includes an oscillator 41 that converts electric power into an electric signal, and a vibrator 42 that converts the electric signal converted by the oscillator 41 into ultrasonic vibration. The oscillator 41 is included on the vehicle body frame 10. The vibrator 42 is included on the dump body 12.

The oscillator 41 and the vibrator 42 are energized in a seated state of the dump body 12. The seated state of the dump body 12 means a state in which the dump body 12 is in the loading posture (posture in which the dump body 12 is lowered). In the example of FIG. 1, the seated state of the dump body 12 is indicated by a solid line.

The oscillator 41 is included between the front wheels 21 and the rear wheels 22. The oscillator 41 is included outside the vehicle body frame 10 in the vehicle width direction. For example, a support member (for example, bracket or the like) for supporting the oscillator 41 may be included outside the vehicle body frame 10.

The vibrator 42 is included at an outer corner portion 60 of the front lower portion of the dump body 12. The outer corner portion 60 corresponds to an outer corner of the dump body 12 in the vehicle width direction. In the example of FIG. 2, two vibrators 42 are included at both outer corner portions 60 of the front lower portion of the dump body 12 one by one. Note that the number of vibrators 42 is not limited to the above. For example, the number of vibrators 42 may be one or three or more. For example, the number of vibrators 42 can be changed according to the design specification.

The dump body 12 includes an inner wall 61 included inside the dump body 12 and on which a load is loaded and an outer wall 62 included outside the dump body 12 with respect to the inner wall 61. The vibrator 42 is included between the inner wall 61 and the outer wall 62. In FIG. 3, illustration of the outer wall 62 is omitted.

The inner wall 61 includes the inner bottom portion 63 that is curved or bent downward in the seated state of the dump body 12. In the example of FIG. 3, the inner bottom portion 63 is curved in an arc shape toward the front lower side. The vibrator 42 is included on a surface 64 (hereinafter, also referred to as “bottom lower surface 64”) of the inner bottom portion 63 opposite to the portion where a load is loaded.

In the present embodiment, the oscillator 41 and the vibrator 42 are connected to each other by a wire 50 (corresponding to an electric wire). The wire 50 includes a first portion 51 included on the vehicle body frame 10 and a second portion 52 included on the dump body 12.

An upstream end of the first portion 51 is connected to the oscillator 41. For example, the first portion 51 extends from the oscillator 41 to the vicinity of the rotation unit 11. For example, a portion that connects the first portion 51 and the second portion 52 in the vicinity of the rotation unit 11 may include a bendable or stretchable member separately from the wire 50 itself.

A downstream end of the second portion 52 is connected to the vibrator 42. For example, the second portion 52 extends from the vicinity of the rotation unit 11 to the vibrator 42. For example, at least a part of the second portion 52 may be included between the inner wall 61 and the outer wall 62.

The dump body 12 includes a rib 65 along one surface of the dump body 12. For example, the rib 65 functions as a reinforcing member of the dump body 12. For example, at least a part of the second portion 52 may be included along the rib 65. For example, the rib 65 may have a rectangular cross-sectional shape. For example, at least a part of the second portion 52 may be disposed in the internal space of the rib 65.

The dump body 12 includes a cross member 66 for reinforcing the dump body 12. The cross member 66 extends in the vehicle width direction. For example, the cross member 66 is formed in a U-shaped cross-sectional shape. The cross member 66 is included on the bottom lower surface 64. For example, the cross member 66 is joined to the bottom lower surface 64 by welding or the like.

The cross member 66 is coupled to a plurality of ribs 65. In the example of FIG. 3, the cross member 66 is coupled to front end side upper portions of the plurality of ribs 65 that extends in the front and rear direction along the lower surface of the dump body 12 (one example on one surface of the dump body 12). The cross member 66 is also coupled to lower ends of the ribs 65 that extend in the vertical direction along the front surface of the dump body 12 (one example on one surface of the dump body 12).

For example, the vibrator 42 may be included on the outer portion of the cross member 66 on the bottom lower surface 64. The outer portion of the cross member 66 corresponds to a portion that faces the outer space of the cross member 66 in the bottom lower surface 64.

Hereinafter, a vibrator 42A included on the outer portion of the cross member 66 is also referred to as “outer member vibrator 42A”. In the example of FIG. 3, one outer member vibrator 42A is illustrated. Note that the number of outer member vibrators 42A is not limited to the above, and may be two or more. For example, the number of outer member vibrators 42A can be changed according to the design specification.

For example, the vibrator 42 may be included on the inner portion of the cross member 66 on the bottom lower surface 64. The inner portion of the cross member 66 corresponds to a portion that faces the inner space of the cross member 66 in the bottom lower surface 64.

Hereinafter, a vibrator 42B included on the inner portion of the cross member 66 is also referred to as “inner member vibrator 42B”. In the example of FIG. 3, one inner member vibrator 42B is illustrated. Note that the number of inner member vibrators 42B is not limited to the above, and may be two or more. For example, the number of inner member vibrators 42B can be changed according to the design specification.

### <Fuel Cell System>

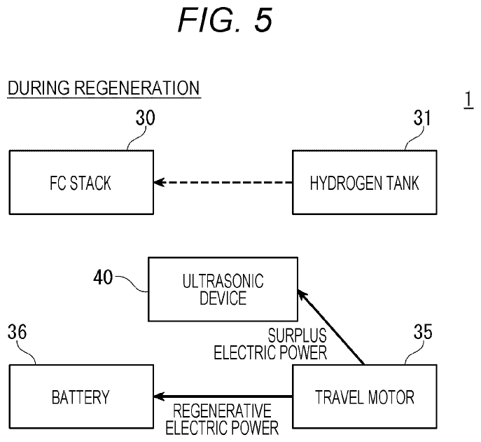

FIG. 4 is an explanatory diagram of a flow of electricity or the like during traveling in a fuel cell system 1 according to the first embodiment. FIG. 5 is an explanatory diagram of a flow of electricity or the like during regeneration in the fuel cell system 1 according to the first embodiment. In the drawing, a flow of electricity is indicated by a solid arrow, a flow of hydrogen is indicated by a broken arrow, and a flow of generated water (water) is indicated by an alternate long and short dash line arrow.

Referring also to FIGS. 4 and 5, the fuel cell system 1 (example of the system) includes the drive source 30 (corresponding to an FC stack), a hydrogen tank 31, a travel motor 35, a battery 36, and the ultrasonic device 40. For example, components of the fuel cell system 1 are included in the vehicle body frame 10 except for the vibrator 42 and the like of the ultrasonic device 40 (including the second portion 52 of the wire 50).

The drive source 30 is a fuel cell (FC) that generates power by chemically reacting hydrogen as a fuel gas with oxygen as an oxidizing gas. For example, the fuel cell includes a stack structure in which a plurality of unit cells is stacked. For example, the fuel cell generates power using oxygen contained in the outside air. Note that air containing oxygen may be supplied to the fuel cell by an oxidizing gas supply device (not illustrated).

The hydrogen tank 31 is a tank that stores hydrogen. For example, the hydrogen tank 31 preferably has a cylindrical shape. In the example of the drawing, one hydrogen tank 31 is illustrated. Note that the shape and number of hydrogen tanks 31 are not limited to the above. For example, the hydrogen tank 31 may have a flat shape. For example, the number of hydrogen tanks 31 may be two or more. For example, the shape and number of hydrogen tanks 31 can be changed according to the design specification.

The travel motor 35 is a motor for causing the dump truck 2 to travel. The travel motor 35 is electrically connected to the drive source 30. The travel motor 35 is connected to the rear wheels 22 of the traveling device 13. The rotational force generated by the travel motor 35 is transmitted to the rear wheels 22 of the traveling device 13.

For example, the battery 36 is a secondary battery such as a lithium ion battery. The battery 36 is electrically connected to the travel motor 35. For example, the electric power charged in the battery 36 is used as drive energy during powering by the dump truck 2. The battery 36 stores regenerative electric power of the travel motor 35 generated during traveling downhill or performing deceleration by the dump truck 2. Note that the battery 36 may store electric power generated by the drive source 30.

The ultrasonic device 40 emits an ultrasonic wave using electric power. In the present embodiment, moisture contained in a load loaded on the dump body 12 is vibrated by an ultrasonic wave emitted by the ultrasonic device 40. For example, since clayey soil (example of a load) also contains moisture, vibration of moisture by an ultrasonic wave contributes to improvement of the soil discharging property. In the present embodiment, in order to improve the soil discharging property, an ultrasonic wave is used instead of heating of the dump body 12 using waste heat of exhaust gas of an engine (internal combustion engine).

The ultrasonic device 40 is electrically connected to the travel motor 35. The ultrasonic device 40 operates using surplus electric power generated in the dump truck 2. For example, the ultrasonic device 40 uses, as electric power, regenerative electric power of the travel motor 35 generated during traveling downhill or performing deceleration by the dump truck 2. The ultrasonic device 40 uses, as the electric power, surplus electric power that is not charged in the battery 36 of the regenerative electric power generated by the travel motor 35.

For example, information related to electric power that can be charged in the battery 36 (hereinafter, also referred to as “battery capacity”) and regenerative electric power generated by the travel motor 35 (hereinafter, also referred to as “motor power generation amount”) may be input to a controller (not illustrated).

For example, the controller may determine that the regenerative electric power generated by the travel motor 35 is not charged in the battery 36 in a case where the motor power generation amount exceeds the battery capacity. For example, the controller may calculate an amount obtained by subtracting the battery capacity (specifically, remaining capacity of the battery 36) from the motor power generation amount as surplus electric power.

### <Flow of Electricity or Like During Traveling>

Next, an example of a flow of electricity or the like during traveling of the dump truck 2 will be described with reference to FIG. 4 and the like.

Hydrogen in the hydrogen tank 31 is supplied to the drive source 30. The drive source 30 generates power by chemically reacting hydrogen as a fuel gas with oxygen as an oxidizing gas. The drive source 30 generates power using oxygen contained in the outside air. Generated water generated from the drive source 30 is drained (for example, discharged to outside).

Electric power (hereinafter, also referred to as “FC output”) generated by the drive source 30 is used as drive energy of the travel motor 35. The rear wheels 22, which are drive wheels, are rotated by driving of the travel motor 35. As a result, the dump truck 2 travels. The electric power charged in the battery 36 is used as drive energy of the travel motor 35 during powering (for example, during loaded vehicle traveling, climbing, or the like) by the dump truck 2. The battery 36 is discharged to compensate for shortage of the FC output.

### <Flow of Electricity or Like During Regeneration>

Next, an example of a flow of electricity or the like during regeneration (for example, during traveling downhill or performing deceleration) by the dump truck 2 will be described with reference to FIG. 5 and the like. The battery 36 is charged with regenerative electric power of the travel motor 35 generated during traveling downhill or performing deceleration by the dump truck 2. Surplus electric power that is not charged in the battery 36 in the regenerative electric power generated by the travel motor 35 is used as electric power used by the ultrasonic device 40.

In the ultrasonic device 40, the oscillator 41 and the vibrator 42 are energized by the surplus electric power. The oscillator 41 converts the surplus electric power into an electric signal. The vibrator 42 converts the electric signal converted by the oscillator 41 into ultrasonic vibration. The moisture contained in a load loaded on the dump body 12 vibrates by the ultrasonic vibration of the oscillator 41 (corresponding to an ultrasonic wave emitted by the ultrasonic device 40). Accordingly, the ultrasonic device 40 is used as a means for improving the soil discharging property.

### Operation and Effect

As described above, the dump truck 2 of the present embodiment includes the dump body 12 rotatably coupled to the vehicle body frame 10 and on which a load is loaded. The dump truck 2 includes the ultrasonic device 40 that emits an ultrasonic wave. The ultrasonic device 40 is included on the dump body 12.

According to this configuration, the soil discharging property can be improved by vibrating moisture contained in a load loaded on the dump body 12 by an ultrasonic wave emitted from the ultrasonic device 40. Furthermore, excessive electric power does not need to be supplied as compared with the case where an electric heating line is included in the cargo bed. Therefore, the soil discharging property can be improved and the electric power consumption can be reduced.

In the present embodiment, the ultrasonic device 40 is included at the front lower portion of the dump body 12. A load such as earth and sand or a crushed stone is more likely to adhere to the front lower portion of the dump body 12 than to the rear portion of the dump body 12. Therefore, as compared with a case where the ultrasonic device 40 is included at the rear portion of the dump body 12, the soil discharging property can be more effectively improved and the electric power consumption can be reduced.

In the present embodiment, the dump truck 2 does not include an internal combustion engine.

According to this configuration, no exhaust gas of the internal combustion engine is generated. Therefore, zero emission toward carbon neutral can be achieved. For example, in a case where the dump body 12 is heated using waste heat of exhaust gas of an internal combustion engine, there is a high possibility that an issue of accumulation of soot due to the exhaust gas and coating burn due to heat occurs. On the other hand, according to the present configuration, an ultrasonic wave is used instead of heating of the dump body 12 using waste heat of exhaust gas, so that the above issue does not occur. Therefore, coating burn and the like can be prevented, which contributes to improvement of appearance quality.

In the present embodiment, the dump truck 2 includes the drive source 30 using hydrogen as fuel.

According to this configuration, since driving using hydrogen as fuel is enabled, zero emission for carbon neutral can be achieved.

In the present embodiment, the ultrasonic device 40 operates according to a command from an operator.

According to this configuration, the ultrasonic device 40 can be operated at any timing. Therefore, electric power consumption can be reduced as compared with a case where the ultrasonic device 40 is constantly operated.

In the present embodiment, the ultrasonic device 40 operates using surplus electric power generated in the dump truck 2.

According to this configuration, the surplus electric power generated in the dump truck 2 can be effectively used as electric power for operating the ultrasonic device 40. Therefore, loss of surplus electric power can be reduced.

In the present embodiment, the ultrasonic device 40 includes the oscillator 41 that converts electric power into an electric signal, and the vibrator 42 that converts the electric signal converted by the oscillator 41 into ultrasonic vibration. The oscillator 41 is included on the vehicle body frame 10. The vibrator 42 is included on the dump body 12.

According to this configuration, since the oscillator 41 and the vibrator 42 can be separately included on the vehicle body frame 10 and the dump body 12, respectively, the degree of freedom of the layout of the oscillator 41 and the vibrator 42 can be increased. For example, as compared with a case where the ultrasonic device 40 in which the oscillator 41 and the vibrator 42 are integrated is included on the dump body 12, the vibrator 42 can be disposed using a dead space of the dump body 12.

In the present embodiment, the oscillator 41 and the vibrator 42 are energized in a seated state of the dump body 12.

According to this configuration, the ultrasonic device 40 can be operated in a seated state of the dump body 12. Therefore, electric power consumption can be reduced as compared with a case where the ultrasonic device 40 is constantly operated (for example, in the case of operating in both a seated state and a dumping state). Note that the dumping state means a state in which the dump body 12 is in the dumping posture (posture in which the dump body 12 is raised) (corresponding to the case of discharging soil).

In the present embodiment, the vibrator 42 is included at the outer corner portion 60 of the front lower portion of the dump body 12.

According to this configuration, ultrasonic vibration is applied from the outer corner portion 60 of the front lower portion of the dump body 12 by the vibrator 42. A load such as earth and sand or a crushed stone is likely to adhere particularly to the outer corner portion 60 of the front lower portion of the dump body 12 in the front lower portion of the dump body 12. Therefore, as compared with a case where the vibrator 42 is included at the central portion of the front lower portion of the dump body 12 (central portion in the vehicle width direction), the soil discharging property can be more effectively improved and the electric power consumption can be reduced.

In the present embodiment, the dump body 12 includes the inner wall 61 included inside the dump body 12 and on which a load is loaded and the outer wall 62 included outside the dump body 12 with respect to the inner wall 61. The vibrator 42 is included between the inner wall 61 and the outer wall 62.

According to this configuration, the vibrator 42 can be protected by the inner wall 61 and the outer wall 62 of the dump body 12. Therefore, an external factor (for example, flying stone or the like) can be prevented from affecting the vibrator 42.

In the present embodiment, the inner wall 61 includes the inner bottom portion 63 that is curved or bent downward in the seated state of the dump body 12. The vibrator 42 is included on the surface 64 of the inner bottom portion 63 opposite to the portion where a load is loaded.

A load such as earth and sand or a crushed stone is likely to adhere particularly to the inner bottom portion 63 of the dump body 12 in the inner wall 61 of the dump body 12. Therefore, ultrasonic vibration is applied by the vibrator 42 from the surface 64 on the side opposite to a portion where a load is loaded in the inner bottom portion 63, so that the soil discharging property can be more effectively improved and the electric power consumption can be reduced.

### Second Embodiment

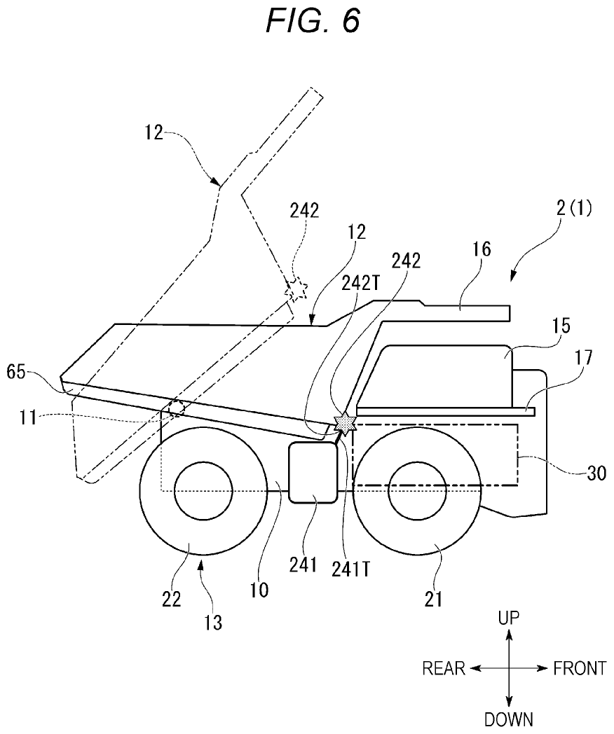

FIG. 6 is a side view of a dump truck 2 according to a second embodiment. In the first embodiment, an example in which the oscillator 41 and the vibrator 42 are connected to each other by the wire 50 (see FIG. 1) has been described. As illustrated in FIG. 6, the second embodiment is different from the first embodiment in that an oscillator 241 and a vibrator 242 are connected to each other by terminals 241T and 242T (example of contacts). In the following description, components similar to those of the first embodiment are denoted by the same reference numerals, and description thereof is omitted.

Referring also to FIG. 6, in the present embodiment, the oscillator 241 and the vibrator 242 are connected to each other by the terminals 241T and 242T. Hereinafter, the terminal 241T included in the oscillator 241 is also referred to as “oscillator-side terminal 241T”, and the terminal 242T included in the vibrator 242 is also referred to as “vibrator-side terminal 242T”. The oscillator-side terminal 241T is included on a vehicle body frame 10 together with the oscillator 241. The vibrator-side terminal 242T is included on a dump body 12 together with the vibrator 242.

In the present embodiment, the vibrator-side terminal 242T comes into contact with the oscillator-side terminal 241T in a seated state of the dump body 12. On the other hand, the vibrator-side terminal 242T does not come into contact with the oscillator-side terminal 241T in a dumping state of the dump body 12. In the present embodiment, the oscillator 241 and the vibrator 242 are energized in the seated state of the dump body 12, and are not energized in the dumping state.

For example, a pad may be included between the dump body 12 and the vehicle body frame 10, the pad functioning as a buffer member that alleviates impact received from the vehicle body frame 10 in a case where the dump body 12 operates. In a case where the pad is included between the dump body 12 and the vehicle body frame 10, a terminal is preferably disposed at the center of the pad. For example, in a case where the pad is included on the dump body 12, the vibrator-side terminal 242T is preferable disposed at the center of the lower surface of the pad.

### Operation and Effect

In the present embodiment, the oscillator 241 and the vibrator 242 are connected to each other by the terminals 241T and 242T.

According to this configuration, the wire 50 for connecting the oscillator 241 and the vibrator 242 is unnecessary. Therefore, the number of components of the wire 50 can be reduced, and the cost can be reduced. Furthermore, time and effort do not need to be taken for an installation work of the wire 50.

In the present embodiment, the oscillator 241 and the vibrator 242 are energized in the seated state of the dump body 12, and are not energized in the dumping state. According to this configuration, electric power consumption can be reduced as compared with a case where the oscillator 241 and the vibrator 242 are constantly energized (for example, in the case of performing energization in both the seated state and the dumping state).

### Modifications

In the above-described embodiments, an example in which the ultrasonic device is included at the front lower portion of the dump body has been described, but the present invention is not limited thereto. For example, the ultrasonic device may not be included at the front lower portion of the dump body. For example, the ultrasonic device may be included at the rear portion of the dump body. For example, the installation mode of the ultrasonic device can be changed according to the design specification.

In the above-described embodiments, an example in which the dump truck does not include an internal combustion engine has been described, but the present invention is not limited thereto. For example, the dump truck may include an internal combustion engine. For example, the installation mode of the internal combustion engine can be changed according to the design specification.

In the above-described embodiments, an example in which an ultrasonic wave is used instead of heating of the dump body using waste heat of exhaust gas of an engine in order to improve the soil discharging property has been described, but the present invention is not limited thereto. For example, an ultrasonic wave may be used together with heating of the dump body using waste heat of exhaust gas of the engine. For example, the mode for improving the soil discharging property can be changed according to the design specification.

In the above-described embodiments, an example in which the ultrasonic device operates according to a command from an operator has been described, but the present invention is not limited thereto. For example, the ultrasonic device may operate without a command from an operator. For example, the ultrasonic device may be constantly operated. For example, the operation mode of the ultrasonic device can be changed according to the design specification.

In the above-described embodiments, an example in which the ultrasonic device operates using surplus electric power generated in the dump truck has been described, but the present invention is not limited thereto. For example, the ultrasonic device may operate without using surplus electric power generated in the dump truck. For example, the ultrasonic device may operate using electric power from a drive source (for example, fuel cell) included in the dump truck, a battery, or the like (the electric power is electric power other than surplus electric power). For example, the mode of electric power for operating the ultrasonic device can be changed according to the design specification.

In the above-described embodiments, an example has been described in which the ultrasonic device includes the oscillator that converts electric power into an electric signal and the vibrator that converts the electric signal converted by the oscillator into ultrasonic vibration, in which the oscillator is included on the vehicle body frame, and the vibrator is included on the dump body, but the present invention is not limited thereto. For example, the oscillator and the vibrator may not be separately included for the vehicle body frame and the dump body, respectively. For example, an ultrasonic device in which the oscillator and the vibrator are integrated may be included on the dump body. For example, the installation mode of the oscillator and the vibrator can be changed according to the design specification.

In the above-described embodiments, an example in which the oscillator and the vibrator are energized in the seated state of the dump body has been described, but the present invention is not limited thereto. For example, the oscillator and the vibrator may be energized in a state other than the seated state of the dump body. For example, the oscillator and the vibrator may be energized in both the seated state and the dump state of the dumping body. For example, the mode of energizing the oscillator and the vibrator can be changed according to the design specification.

In the above-described embodiments, an example in which the vibrator is included at the outer corner portion of the front lower portion of the dump body has been described, but the present invention is not limited thereto. For example, the ultrasonic device may be included at the central portion of the front lower portion of the dump body (central portion in the vehicle width direction). For example, the installation mode of the vibrator at the front lower portion of the dump body can be changed according to the design specification.

In the above-described embodiments, an example has been described in which the dump body includes the inner wall included inside the dump body and on which a load is loaded and the outer wall included outside the dump body with respect to the inner wall, and the vibrator is included between the inner wall and the outer wall, but the present invention is not limited thereto. For example, the vibrator may be included outside the outer wall. For example, the vibrator may be built in the inner wall. For example, the installation mode of the vibrator on the inner wall and the outer wall of the dump body can be changed according to the design specification.

In the above-described embodiments, an example has been described in which the inner wall includes the inner bottom portion that is curved or bent downward in the seated state of the dump body, but the present invention is not limited thereto. For example, the inner bottom portion may not be curved or bent downward in the seated state of the dump body. For example, the inner bottom portion may have a shape bent so as to be convex (for example, to have an acute angle) downward in the seated state of the dump body. For example, the mode of the inner bottom portion can be changed according to the design specification.

In the above-described embodiments, an example in which the dump truck further includes the travel motor that causes the dump truck to travel has been described, but the present invention is not limited thereto. For example, the dump truck may not include the travel motor. For example, in a case where the drive source is a hydrogen engine, the dump truck may travel by driving the hydrogen engine. For example, the installation mode of the travel motor can be changed according to the design specification.

In the above-described embodiments, an example in which the dump truck further includes the battery that stores regenerative electric power generated by the travel motor has been described, but the present invention is not limited thereto. For example, in a case where the drive source is a hydrogen engine, the dump truck may not include the battery. For example, the installation mode of the battery can be changed according to the design specification.

In the above-described embodiments, an example in which the drive source is a fuel cell (FC) that generates power by chemically reacting hydrogen as a fuel gas with oxygen as an oxidizing gas, but the present invention is not limited thereto. For example, the drive source may be a hydrogen engine that is an internal combustion engine using hydrogen as a fuel. For example, the drive source may include a fuel cell and a hydrogen engine. For example, the formation mode of the drive source can be changed according to the design specification.

In the above-described embodiments, an example in which the dump truck is a fuel cell vehicle including a fuel cell as the drive source has been described, but the present invention is not limited thereto. For example, the dump truck may be a trolley-type dump truck (trolley vehicle) including a current collection device that obtains electric power from an overhead line. For example, the dump truck may be an engine vehicle including an internal combustion engine. For example, the mode of the dump truck can be changed according to the design specification.

Although the embodiments of the present invention have been described above, the present invention is not limited thereto, and addition, omission, substitution, and other changes of configurations can be made without departing from the gist of the present invention, and the above-described embodiments can be appropriately combined.

### Supplement 1

A dump truck including a dump body rotatably coupled to a vehicle body frame and on which a load is loaded, the dump truck including
an ultrasonic device that emits an ultrasonic wave, in which
the ultrasonic device is included on the dump body.

### Supplement 2

The dump truck according to Supplement 1, in which
the ultrasonic device is included at a front lower portion of the dump body.

### Supplement 3

The dump truck according to Supplement 1 or 2, in which
the dump truck does not include an internal combustion engine.

### Supplement 4

The dump truck according to any one of Supplements 1 to 3, in which
the dump truck includes a drive source that uses hydrogen as fuel.

### Supplement 5

The dump truck according to any one of Supplements 1 to 4, in which
the ultrasonic device operates according to a command from an operator.

### Supplement 6

The dump truck according to any one of Supplements 1 to 5, in which
the ultrasonic device operates using surplus electric power generated by the dump truck.

### Supplement 7

The dump truck according to any one of Supplements 1 to 6, in which
the ultrasonic device includes:
an oscillator that converts electric power into an electric signal; and
a vibrator that converts the electric signal converted by the oscillator into ultrasonic vibration, in which
the oscillator is included on the vehicle body frame, and
the vibrator is included on the dump body.

### Supplement 8

The dump truck according to Supplement 7, in which
the oscillator and the vibrator are energized in a seated state of the dump body.

### Supplement 9

The dump truck according to Supplement 7 or 8, in which
the vibrator is included at an outer corner portion of a front lower portion of the dump body.

### Supplement 10

The dump truck according to any one of Supplements 7 to 9, in which
the dump body includes:
an inner wall included inside the dump body and on which the load is loaded; and
an outer wall included outside the dump body with respect to the inner wall, and
the vibrator is included between the inner wall and an outer wall.

### Supplement 11

The dump truck according to Supplement 10, in which
the inner wall includes an inner bottom portion curved or bent downward in a seated state of the dump body, and
the vibrator is included on a surface of the inner bottom portion on a side opposite to a portion where the load is loaded.

Reference Signs List

| | |
|---|---|
| 2 | Dump truck (work vehicle) |
| 30 | Drive source |
| 40 | Ultrasonic device |
| 41 | Oscillator |
| 42 | Vibrator |
| 60 | Outer corner portion |
| 61 | Inner wall |
| 62 | Outer wall |
| 63 | Inner bottom portion |
| 64 | Bottom lower surface (surface of the inner bottom |
| | portion opposite to the portion where a load is loaded) |

1. A dump truck comprising a dump body rotatably coupled to a vehicle body frame and on which a load is loaded, the dump truck comprising
an ultrasonic device that emits an ultrasonic wave, wherein
the ultrasonic device is included on the dump body.

2. The dump truck according to claim 1, wherein
the ultrasonic device is included at a front lower portion of the dump body.

3. The dump truck according to claim 1, wherein
the dump truck does not include an internal combustion engine.

4. The dump truck according to claim 1, wherein
the dump truck includes a drive source that uses hydrogen as fuel.

5. The dump truck according to claim 1, wherein
the ultrasonic device operates according to a command from an operator.

6. The dump truck according to claim 1, wherein
the ultrasonic device operates using surplus electric power generated by the dump truck.

7. The dump truck according to claim 1, wherein
the ultrasonic device includes:
an oscillator that converts electric power into an electric signal; and
a vibrator that converts the electric signal converted by the oscillator into ultrasonic vibration, wherein
the oscillator is included on the vehicle body frame, and
the vibrator is included on the dump body.

8. The dump truck according to claim 7, wherein
the oscillator and the vibrator are energized in a seated state of the dump body.

9. The dump truck according to claim 7, wherein
the vibrator is included at an outer corner portion of a front lower portion of the dump body.

10. The dump truck according to claim 7, wherein
the dump body includes:
an inner wall included inside the dump body and on which the load is loaded; and
an outer wall included outside the dump body with respect to the inner wall, and
the vibrator is included between the inner wall and an outer wall.

11. The dump truck according to claim 10, wherein
the inner wall includes an inner bottom portion curved or bent downward in a seated state of the dump body, and
the vibrator is included on a surface of the inner bottom portion on a side opposite to a portion where the load is loaded.

12. The dump truck according to claim 2, wherein
the dump truck does not include an internal combustion engine.

13. The dump truck according to claim 2, wherein
the dump truck includes a drive source that uses hydrogen as fuel.

14. The dump truck according to claim 2, wherein
the ultrasonic device operates according to a command from an operator.

15. The dump truck according to claim 2, wherein
the ultrasonic device operates using surplus electric power generated by the dump truck.

16. The dump truck according to claim 2, wherein
the ultrasonic device includes:
an oscillator that converts electric power into an electric signal; and
a vibrator that converts the electric signal converted by the oscillator into ultrasonic vibration, wherein
the oscillator is included on the vehicle body frame, and
the vibrator is included on the dump body.

17. The dump truck according to claim 16, wherein
the oscillator and the vibrator are energized in a seated state of the dump body.

18. The dump truck according to claim 16, wherein
the vibrator is included at an outer corner portion of a front lower portion of the dump body.

19. The dump truck according to claim 16, wherein
the dump body includes:
an inner wall included inside the dump body and on which the load is loaded; and
an outer wall included outside the dump body with respect to the inner wall, and
the vibrator is included between the inner wall and an outer wall.

20. The dump truck according to claim 19, wherein
the inner wall includes an inner bottom portion curved or bent downward in a seated state of the dump body, and
the vibrator is included on a surface of the inner bottom portion on a side opposite to a portion where the load is loaded.
